(19) United States
(12) Patent Application Publication
(10) Pub. No.: US 2006/0262730 A1
(43) Pub. Date: Nov. 23, 2006

(54) System for analyzing modified analysis data with a view to optimizing a communication network

(75) Inventors: Lionel Fournigault, Gif Sur Yvette (FR); Stephane Betge-Brezetz, Paris (FR); Arnaud Gonguet, Paris (FR); Gerard Delegue, Cachan (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/435,987

(22) Filed: May 18, 2006

(30) Foreign Application Priority Data
May 19, 2005 (EP) 05300389.3

(51) Int. Cl. H04J 3/14

(52) U.S. Cl. 370/251

(57) ABSTRACT

A system is dedicated to analyzing analysis data for a system for optimizing and/or managing and/or supervising a communication network including network elements through which traffic defined locally by analysis data passes. The analysis system includes analysis means for determining which analysis data of at least one selected type obtained in a selected time interval has been modified and then determining modified analysis data that satisfies at least one selected criterion in order to deliver analysis results representing at least some of the modified analysis data satisfying each selected criterion with a view to its use by said network optimization and/or management and/or supervision system.

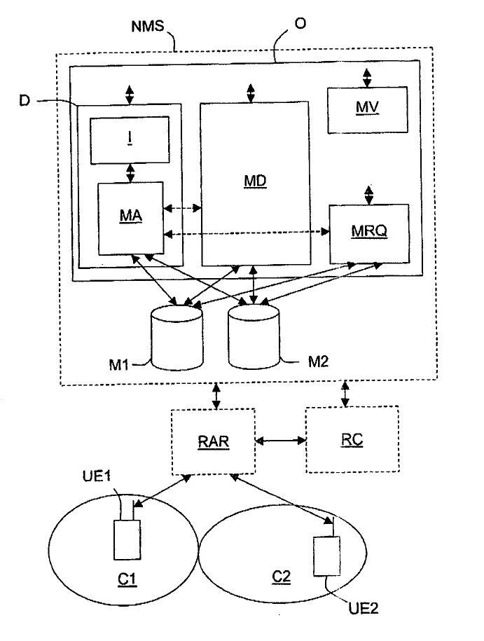

### CROSS-REFERENCE TO RELATED APPLICATIONS

This application is based on French Patent Application No. 05300389.3 filed 19 May 2005, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to communication networks and more particularly to optimizing the operation and/or the configuration of communication networks.

2. Description of the Prior Art

The supervision and management of communication networks, and in particular of cellular or mobile radio networks (for example GSM, GPRS/EDGE and UMTS networks), is increasingly difficult, in particular as a result of network densification and/or expansion, the coexistence of different network technologies, and improvement in and/or diversification of quality of service (QoS).

One objective of communication network supervision and management is to optimize a network in order to make best possible use of its communication resources (in particular its radio channels in the case of a cellular or mobile radio network), especially as communication network deployment and operation costs are high.

Optimizing a network, and thus managing the use of its resources, requires analysis data, for example traffic data that defines the traffic passing through the network elements, network parameters or indicators, for example quality of service indicators.

In the present context, the expression “traffic data” refers to parameter or indicator values that can be measured or estimated by a network management system (NMS) and the term “network element” refers to any physical and/or logical component of a network through which traffic defined locally by parameter or indicator values passes. Thus it might refer, for example, to a cell in which mobile terminals can set up or continue calls or to a network equipment such as a router, a base station or a radio network controller.

Networks are supervised and managed using a network optimization system (or tool), for example, such as the RNO® (Radio Network Optimization) system developed by ALCATEL for cellular radio networks. This kind of system is used to monitor the changing quality of service in certain network elements, for example cells, to diagnose causes of problems, in particular quality of service problems, and to propose solutions to problems.

Existing network optimization systems display an analysis data value (also called an operational value), the difference between that value and the intended analysis data value (also called the scheduled value) and the variation of analysis data over a selected time period. This is undoubtedly useful, but offers a network operator only a very partial view of how his network is evolving, and one that does not enable him to understand exactly what impact certain analysis data modifications or certain adjustments may have on his network.

An object of the invention is to improve on this situation and more specifically to enable network operators to analyze the analysis data record from different points of view and to monitor the impact of network adjustments, in particular in the case of cellular or radio communication networks.

### SUMMARY OF THE INVENTION

To this end the invention proposes a system dedicated to analyzing analysis data for a system (or tool) for optimizing and/or managing and/or supervising a communication network including network elements through which traffic defined locally by analysis data passes.

The analysis system includes analysis means for determining which analysis data of at least one selected type obtained in a selected time interval has been modified and then determining modified analysis data that satisfies at least one selected criterion in order to deliver analysis results representing at least some of the modified analysis data satisfying each selected criterion with a view to its use by said network optimization and/or management and/or supervision system.

The analysis system of the invention may have other features, and in particular, separately or in combination:

each criterion may be selected from a group comprising at least one modification magnitude criterion, one criterion of belonging to a set of selected analysis data types, one criterion of representing at least one selected network element type, one criterion of belonging to network elements in a selected geographical region, one criterion of correlation with at least one selected deployed service and one criterion of difference from respective expected values;

its analysis means may be adapted to deliver the analysis results in the form of a list including at least the analysis data that has been the subject of the greatest modification in the selected time period and satisfies each selected criterion;

its analysis means may be adapted to deliver the analysis results in the form of a list including the analysis data that has been the subject of at least the two greatest modifications in the selected time period and satisfies each selected criterion; the list may be ordered as a function of the magnitude of the modification;

its analysis means may be adapted to determine the magnitude of each analysis data modification as a function of the difference between the value of the analysis data and its corresponding expected value;

its analysis means may be adapted to determine the number of elements of the same type subject to modification in the selected time period;

its analysis means may be adapted to determine the average value of a modified analysis data item in the selected time period;

the time period may selected from one day, one week, one month, one quarter, one half-year and one year;

it may include a man/machine interface adapted to enable a user to define analysis functions that can be executed by said analysis means.

The invention also proposes an optimization and/or management and/or supervision system (or tool) for a communication network including an analysis system of the above type. This system (or tool) may display at least some analysis results delivered by the analysis system to enable visual use thereof. Instead of or as well as this, the system (or tool) may diagnose causes of problems occurring in the communication network from analysis results delivered by the analysis system.

The invention is especially well suited to radio communication networks that depend on the external environment and in particular to cellular (or mobile) networks.

### BRIEF DESCRIPTION OF THE DRAWINGS

Other features and advantages of the invention will emerge on reading the following detailed description and examining the appended drawing, the single FIGURE whereof is a diagram of a cellular communication network equipped with a network optimization and/or management and/or supervision system (OO) including one embodiment of an analysis system of the invention. The appended drawing constitutes part of the description of the invention as well as contributing to the definition of the invention, if necessary.

### DETAILED DESCRIPTION OF THE PREFERRED EMBODIMENT

The objects of the invention include offering an analysis of the network analysis data record from different points of view and monitoring the impact of at least some of adjustments to a network.

### Detailed Description of the Preferred Embodiment

The communication network considered hereinafter by way of nonlimiting example is a mobile or cellular radio network such as a GSM, GPRS/EDGE, UMTS or WiMax network, for example. The resources considered hereinafter are therefore radio channels.

As shown in the single FIGURE, broadly speaking, but nevertheless in sufficient detail for the invention to be understood, a cellular radio network may be regarded as a core network (RC) connected to a radio access network RAR (called the UTRAN in a UMTS network and the BSS in a GSM or GPRS/EDGE network) in turn connected to a network management system (NMS).

The radio access network RAR includes base stations (a base station is called a Node B in a UMTS network or a base transceiver station (BTS) in a GSM or GPRS/EDGE network) and, in a UMTS network, radio network controllers (RNC) or, in a GSM or GPRS/EDGE network, base station controllers (BSC), connected to each other and to an access network manager. The base stations are further connected to the network management system NMS via the RNC or BSC.

Each base station (Node B or BTS) is associated with one or more cells Ci covering a radio area in which mobile terminals UEj can set up (or continue) radio connections.

In the present context, the term “mobile terminal” refers to any mobile or portable communication terminal capable of exchanging data in the form of radio signals either with another terminal or a network equipment via their parent network(s) or with its own parent network. Thus it may refer, for example, to mobile telephones or to fixed or portable computers or personal digital assistants (PDA) equipped with a radio communication module.

Two cells (C1 and C2, i=1 or 2) are represented in the present example. However, i can take any non-zero value. Moreover, two mobile terminals (UE1 and UE2, j=1 or 2) are represented in the present example. However, j can take any non-zero value.

The core network RC comprises network equipments connected to the RNC or BSC, to a network manager and to the network management system NMS.

The network management system NMS includes (or is connected to) a network optimization and/or management and/or supervision system (or tool) OO, for example the RNO® system referred to in the introduction, which is used to optimize the use of the communication resources of the (cellular) radio network.

As shown in the single FIGURE, the network optimization and/or management and/or supervision system (or tool) OO includes, for example, a diagnostic module MD for determining the causes of problems occurring in the network, for example a reduced quality of service, and/or a quality of service reporting module MRQ for supplying reports relating to the various qualities of service offered by the network.

The diagnostic module MD and the quality of service reporting module MRQ respectively produce diagnoses and reports based on an analysis of analysis data values, sometimes called operational values, stored in corresponding relationship to a date in a first memory M1 of the network management system NMS, which may take the form of a database. They may equally use complementary values representing at least some analysis data values that are expected (or counted on), known as default values, determined by the network management system NMS. These complementary values, which are sometimes called scheduled values, are stored in a second memory M2 of the network management system NMS, which may take the form of a database.

As indicated in the introduction, in the present context the expression “analysis data” refers to traffic data, network parameters or indicators, for example quality of service indicators.

Moreover, in the present context, the expression “traffic data” refers to parameter or indicator values that can be measured or estimated by the network management system NMS, in particular at the level of the network elements.

Furthermore, in the present context, the expression “network element” refers to any physical and/or logical component of a network through which traffic defined locally by parameter or indicator values passes. It might therefore refer, for example, to a cell Ci in which mobile terminals UEj can set up or continue calls or a network equipment such as a router, a BTS or Node B, or a BSC or RNC.

The invention proposes an analysis data analysis system D adapted to deliver analysis results for use by the network optimization and/or management and/or supervision system (or tool) OO. In the present nonlimiting embodiment, the analysis system D is integrated into the network optimization and/or management and/or supervision system (or tool) OO. However, in a different embodiment, it could instead be connected to that system (or tool) OO.

According to the invention, the analysis system D includes at least one analysis module MA for determining in particular what analysis data values of one or more selected types obtained during a selected time period have been modified.

The analysis data values (operational values) concerned are those stored in the first memory M1 in corresponding relationship to a date.

The time period may vary as a function of the analysis requirements. It may be one day, one week, one month, one quarter, one half-year or one year, for example.

In the present context, the expression “modified analysis data” refers to analysis data representing the same traffic, where applicable at the level of a network element, and subject to variation during a selected time period.

The analysis data may consist of configuration parameters, cartographic data or quality of service data, for example.

The analysis module MA may be configured to retain only analysis data for which the maximum amplitude of the variations (or modifications) over the selected time interval is above an absolute or relative threshold which may vary from one type of analysis data to another (percentage overshoot).

The analysis module MA can determine the amplitude of a modification either by internal comparison of analysis data of the same type over the selected time period or by comparing each item of analysis data of the same type in the selected time period to the corresponding expected default value (stored in the second memory M2).

Each time that the analysis module MA has determined modified analysis data of one or more selected types, it determines which data satisfies at least one selected criteria.

A very large number of criteria may be selected. The number and types of criteria that may be used for the same analysis depend on the type of analysis. These criteria may include, in particular:

A criterion of the magnitude of the modification. Here it is a question of selecting from the modified analysis data either that representing the greatest modification in absolute or relative terms or that having the n largest modifications in absolute or relative terms, the value of n being strictly greater than one (1). The amplitude of a modification may be determined either by internal comparison of analysis data of the same type over the selected time period or by comparing each item of analysis data of the same type in the selected time period to the corresponding expected default value (stored in the second memory M2). For example the two largest (n=2), the five largest (n=5) or the ten largest (n=10) modifications may be selected.

A criterion of belonging to a set of selected analysis data types. Here it is a question of selecting from the modified analysis data at least some data whose types belong to a selected set (for example the set of (or a subset of) data useful to a telecommunication operator).

A criterion of representing at least one selected network element type. Here it is a question of selecting from the modified analysis data at least some data that represents or corresponds to at least one selected type of network element. For example, at least some of the analysis data that relates to a group of cells may be selected, which cells where applicable belong to a selected geographical region.

A criterion of belonging to network elements in a selected geographical area. Here it is a question of selecting from the modified analysis data at least some data that represents or corresponds to all the network element types in the same selected geographical region. For example, at least some of the analysis data that relates to a group of cells may be selected (this groups together the cells but also their respective base stations, where applicable together with their respective network controllers). This in particular enables geographical correlations to be effected.

A criterion of correlation with at least one selected deployed service. Here it is a question of selecting from the modified analysis data at least some data that corresponds to or is correlated with at least one selected deployed service (for example data belonging to a subset of data useful to a telecommunication operator). This in particular enables determination of the real impact on a selected service of modifications made to the network, whether it is old or newly installed, and conversely the impact on the analysis data of installing a new service or removing an old service.

As indicated above, certain criteria may be combined. Thus the criterion of the magnitude of the modification may in particular be combined with the criterion of belonging to a set of selected analysis data types, the criterion of representing at least one selected network element type, the criterion of belonging to network elements in a selected geographical region or the criterion of correlation with at least one selected deployed service.

Combinations of three or more criteria may be used. For example, the criterion of the magnitude of the modification, that of representing at least one selected type of network element and that of belonging to network elements in a selected geographical region may be combined. Generally speaking, the important combinations depend on the context and on the radio network type.

Once the analysis module MA has selected the modified analysis data that satisfies each selected criterion, it delivers analysis results that represent at least some of that data.

The criterion of the magnitude of the modification in particular enables the analysis module MA to deliver analysis results in the form of a list including at least the analysis data that has been subject to the greatest modification over the selected time period while satisfying each selected criterion. Of course, each list may contain analysis data that has been the subject of the (at least) two largest modifications over the selected time period whilst satisfying each selected criterion. For example, the list may contain the five (5) or ten (10) analysis data items that are the subject of the five or ten largest modifications.

Lists of the above kind may be ordered as a function of the magnitude of the modification. For example, the list may cite the analysis data starting with that subjected to the greatest modification and extending to that subjected to the least modification, or vice-versa.

Thanks to these lists, it is possible to determine which ten cells are modified most each month, for example, or the ten types of analysis data values (operational values) modified the most over a selected time period, where appropriate for one or more selected cells (or any other type of network element) and/or for a selected geographical region, or the ten analysis data values (operational values) with the greatest differences with respect to their expected (or scheduled) values over a selected time period.

The analysis module MA may also carry out statistical processing of analysis data values (operational values) for which it has detected a modification over a selected time period. This statistical processing may be applied to the modified analysis data either before or after applying the selected criterion or criteria. Any type of statistical processing may be envisaged.

For example, the analysis module MA may determine the number of network elements of the same type subject to a modification during a selected time period. In particular this makes it possible to determine the number of cells Ci modified each week.

For example, the analysis module MA may determine the average value over a selected time period of an analysis data item that was the subject of a modification during said selected time period.

The results of this statistical processing may constitute analysis results delivered as such by the analysis module MA, but the analysis module MA may also apply one or more criteria of the type discussed above to them, in order to select certain of them to be delivered in the form of analysis results.

As shown in the single FIGURE, the analysis system D may also include a man/machine interface I enabling a user to define analysis functions other than the predefined functions described hereinabove that can be implemented by his analysis module MA. This interface, which is preferably an SQL command line interface, enables the operator to obtain via generic SQL requests information that is not directly available by means of the “standard” analysis functions of the analysis module MA.

For example, a request may consist in searching for parameters x and y modified between dates d1 and d2 whose values relative to the scheduled values are within plus or minus 10% for geographical regions g1 and g2. As a general rule, any type of SQL request may be envisaged.

The analysis results are delivered by the analysis system D for “active” or “passive” use by the network optimization and/or management and/or supervision system OO.

In the present context, the term “passive use” refers to display, where applicable after graphical formatting, and where applicable of a comparative kind. To this end, as shown in the single FIGURE, the network optimization and/or management and/or supervision system OO may include a display module MV. The graphical display may show each operational value (modified analysis data value) selected by the analysis system D, for example, and the corresponding value scheduled (or counted on).

In the present context, the expression “active use” refers either to use by another module, for example the diagnostic module MD in order to determine network elements giving rise to problems and to attempt to find causes of those problems or the quality of service reporting module MRQ in order for it to carry out quality of service analyses, or to matching against other results, for example diagnosis results delivered by the diagnostic module MD, in order to attempt to find a correspondence between them. The matching may be effected by the diagnostic module MD and may be reflected either in comparative processing, leading to results that can be displayed on the display module MV, or in simple comparative display by the display module MV with a view to analysis by the operator.

The analysis system D of the invention, and in particular its analysis module MA and at least some of its man/machine interface I, where present, may be produced in the form of electronic circuits, software (or electronic data processing) modules or a combination of circuits and software.

Thanks to an analysis of the record of analysis data of a network, the invention enables the network operator to obtain a better understanding of how his network is changing, to improve his expertise and to supervise and/or manage his network better, in particular if it is an expanded network and/or a multistandard network, through a knowledge of at least some of the impact of modifications made to the network.

The invention is not limited to the embodiments of an analysis system and a network optimization and/or management and/or supervision system described hereinabove by way of example only and encompasses all embodiments that the person skilled in the art might envisage that fall within the scope of the following claims.

There is claimed:

1. An analysis data analysis system for a system for optimizing and/or managing and/or supervising a communication network including network elements through which traffic defined locally by analysis data passes, which analysis system includes analysis means for determining which analysis data of at least one selected type obtained in a selected time interval has been modified and then determining modified analysis data that satisfies at least one selected criterion in order to deliver analysis results representing at least some of the modified analysis data satisfying each selected criterion with a view to its use by said network optimization and/or management and/or supervision system.

2. A system according to claim 1, wherein each criterion is selected from a group comprising at least one modification magnitude criterion, one criterion of belonging to a set of selected analysis data types, one criterion of representing at least one selected network element type, one criterion of belonging to network elements in a selected geographical region, one criterion of correlation with at least one selected deployed service and one criterion of difference from respective expected values.

3. A system according to claim 2, wherein said analysis means are adapted to deliver said analysis results in the form of a list including at least the analysis data that has been the subject of the greatest modification in said selected time period and satisfies each selected criterion.

4. A system according to claim 2, wherein said analysis means are adapted to deliver said analysis results in the form of a list including the analysis data that has been the subject of at least the two greatest modifications in said selected time period and satisfies each selected criterion.

5. A system according to claim 4, wherein said analysis means are adapted to deliver said analysis results in the form of a list ordered as a function of the magnitude of the modification.

6. A system according to claim 1, wherein said analysis means are adapted to determine the magnitude of an analysis data modification as a function of the difference between the value of said analysis data and a corresponding expected value.

7. A system according to claim 1, wherein said analysis means are adapted to determine the number of elements of the same type subject to modification in said selected time period.

8. A system according to claim 1, wherein said analysis means are adapted to determine the average value of a modified analysis data item in said selected time period.

9. A system according to claim 1, wherein said time period is selected from a group comprising at least one day, one week, one month, one quarter, one half-year and one year.

10. A system according to claim 1, including a man/machine interface adapted to enable a user to define analysis functions adapted to be executed by said analysis means.

11. An optimization and/or management and/or supervision system for a communication network including network elements through which traffic defined locally by analysis data passes, which system includes an analysis system according to any one of the preceding claims.

12. A network optimization and/or management and/or supervision system according to claim 11 adapted to display at least some analysis results delivered by said analysis system to enable visual use thereof.

13. A network optimization and/or management and/or supervision system according to claim 11 adapted to diagnose causes of problems occurring in said communication network from analysis results delivered by said analysis system.
